(19) United States
(12) Patent Application Publication
(10) Pub. No.: US 2018/0105364 A1
(43) Pub. Date: Apr. 19, 2018

(54) CONVEYOR STRUCTURE OF CONVEYOR DRIVEN FABRIC DYEING MACHINE

(71) Applicant: CHI-LUNG CHANG, Taoyuan City (TW)

(72) Inventor: CHI-LUNG CHANG, Taoyuan City (TW)

(21) Appl. No.: 15/668,710

(22) Filed: Aug. 4, 2017

(30) Foreign Application Priority Data
Oct. 14, 2016 (TW) 105215576

(51) Int. Cl. B65G 17/06; D06B 23/04

(52) U.S. Cl. CPC B65G 17/067; B65G 23/06; D06B 23/04

(57) ABSTRACT

A conveyor structure for use with a conveyor driven fabric dyeing machine is provided. The conveyor includes at least one pair of conveyor chains that are parallel to each other, or a similar structure, and a driver roller that guides and drives the conveyor chains. A plurality of conveyance plates are arranged to straddle between the conveyor chains. The conveyance plates have first ends fixed to the conveyor chains and opposite second ends that are free ends and are movable with respect to the conveyor chains. With the conveyance plates that are stiff supporting the weight of fabric, the conveyor, when conveying fabric, is prevented from curving and deformation so that there is no need to additionally provide a support structure, the entire structure is simplified and easy to install and remove for maintenance, and it is hard for debris and contaminants to hide therein and cleaning is made easy.

### (a) TECHNICAL FIELD OF THE INVENTION

The present invention relates generally to a conveyor driven fabric dyeing machine, and more particularly to a conveyor structure that comprises a plurality of rigid conveyance plates mounted on conveyor chains.

### (b) DESCRIPTION OF THE PRIOR ART

A conveyor driven dyeing machine comprises a conveyor. When the conveyor conveys fabric forward, the weight of the fabric may cause a conveyor belt to curve or deform and exhibits a wavy corrugated condition. Heretofore, it is common to provide a support device under the conveyor belt, such as a fixed support member made of a wearable material, or a support device including an array of rollers, or a synchronously operated support chain, in order to keep smooth and stable operation of the conveyor. Further, the wearable material may get worn out and requires replacement and may also cause wear of the conveyor that also requires replacement of parts. The roller array, although generally causing no wear of the conveyor, may still causes a wavy corrugated configuration of the conveyor belt of different extends based on the arrangement density of the rollers. The synchronous support chain is of a high cost.

Further, with the support structure installed inside a machine body of a dyeing machine, the manufacturing cost would be increased due to the complicated structure. In addition, debris or contaminants may readily get stuck or jammed inside the machine body of the dyeing machine and cannot be easily removed. Further, the conveyor belt may get cyclic wear and abrasion occurring in a contact surface thereof with the support structure. Further, due to the installation of the support structure inside the machine body, the limited interior space of the machine body is further limited so that scheduled maintenance and replacement of the conveyor become even harder.

### SUMMARY OF THE INVENTION

An objective of the present invention is to provide an improved conveyor structure that comprises conveyance plates that are stiff for improving a conveyor structure of a conveyor driven fabric dyeing machine, and at the same time simplifying the structure of the conveyor to reduce the manufacturing cost thereof and ease the installation, and also being free of wear and easy to mount, remove, and maintain.

The features of the present invention are that the conveyor comprises a plurality of conveyor chains and a plurality of conveyance plates that are stiff are provided to straddle between the conveyor chains so that such stiff conveyance plates provide support to the fabric that is conveyed by the conveyor so as to prevent curving and wear of the conveyor, wherein the structure is simplified and easy to install and maintenance, is hard to hide debris and contaminants therein, and is easy to clean.

One of the technical solutions of the present invention is that the conveyor for use with a fabric dyeing machine comprises at least one pair of conveyor chains that are arranged parallel to each other and a driver roller to guide and drive the conveyor chains, wherein a plurality of conveyance plates is provided between an straddling between the conveyor chains such that first ends of the conveyance plates are fixed to the conveyor chains and opposite second ends being free ends that are movable with respect to the conveyor chains. With such a structural arrangement, the conveyor chains, when driven by the driver roller, may rotate with the driver roller without being interfered with.

In a preferred embodiment of the present invention, the first ends of the conveyance plates are fixed to the conveyor chains and the second ends are stacked, in a movable manner, on the first ends of the respective adjacent ones of the conveyance plates. As such, the stacking arrangement prevents the conveyance plates from generating a gap therebetween thereby protecting fabric from getting stuck or jammed in the gap.

In another embodiment of the present invention, the first ends of the conveyance plates are fixed to the conveyor chains and the second ends are movably straddling between and supported on the conveyor chains and are located immediately next to the first ends of the respective adjacent ones of the conveyance plates.

In another embodiment of the present invention, the conveyance plates are extended in length thereof to cover or span over multiple sections of the conveyor chains, so that the multiple sections of the conveyor chains share a common one of the conveyance plates (as shown in FIG. 5) to thereby reduce the number of the conveyance plates used.

To allow dye contained in fabric positioned on the conveyance plates to smoothly fall down to a bottom of an interior of a machine body, the present invention is preferably structured such that a plurality of through holes are formed in the conveyance plates to allow the dye liquid to move therethrough.

To prevent the conveyance plates that are used to convey fabric from being corroded by chemical dye liquid and thus extend the service life thereof, the conveyance plates are preferably made of a rigid or stiff material that is resistant to corrosion.

To protect fabric from damage caused by excessive abrasion between the fabric and the conveyance plates, the present invention is preferably structured such that surfaces of the conveyance plates have been subjected to polishing treatment to form smooth surfaces or the surfaces of the conveyance plates are provided with a coating that is resistant to chemical corrosion.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a conveyor structure according to a first embodiment of the present invention.

FIG. 2 is an enlarged view of a circled portion “A” of FIG. 1.

FIG. 3 is a schematic view showing a conveyor structure according to a second embodiment of the present invention.

FIG. 4 is an enlarged view of a circled portion “B” of FIG. 3.

FIG. 5 is a schematic view showing a portion of a conveyor structure according to a third embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

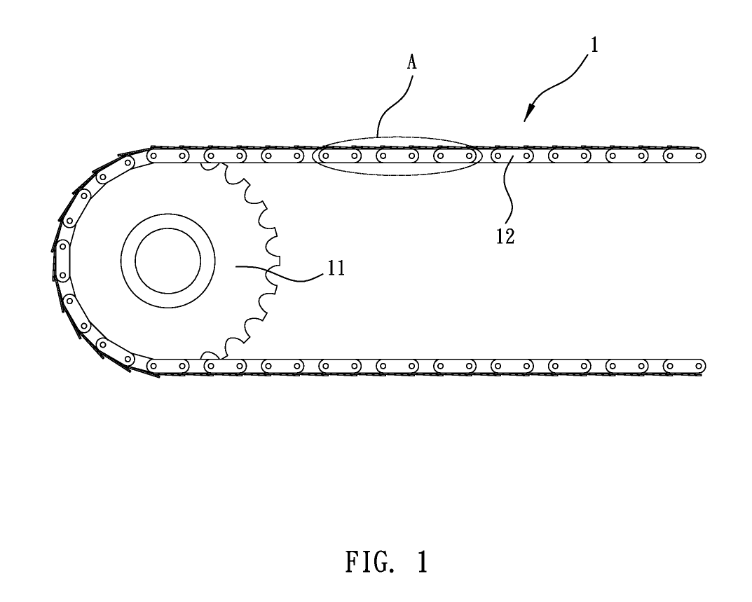

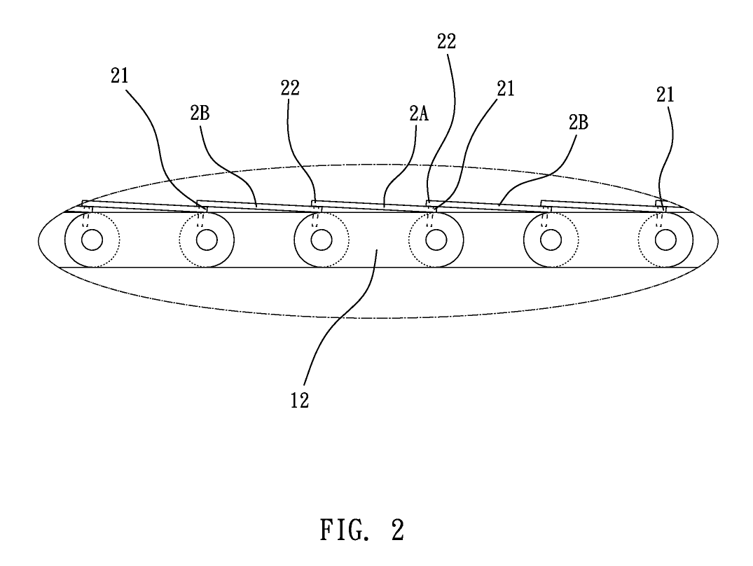

As shown in FIGS. 1 and 2, the present invention provides a structure of a conveyor 1 for use in a conveyor driven fabric dyeing machine, which as a first embodiment, comprises at least one pair of conveyor chains 12 that are arranged parallel and a driver roller 11 that guides and drives the conveyor chains 12. The conveyor 1 is arranged in an interior space of a machine body of the fabric dyeing machine to convey fabric (not shown in the drawings). In other words, the fabric is positioned on the conveyor 1 and the conveyor 1, when driven by the driver roller 11 to move, brings the fabric to move in a cyclic circulating manner.

In the conveyor, a plurality of conveyance plates are provided between and straddling the conveyor chains 12. In this specification, the conveyance plates are divided into a plurality of first conveyance plates 2A and second conveyance plates 2B that are arranged alternate with each other. The first conveyance plates 2A and the second conveyance plates 2B each have two end edges on two opposite ends thereof, wherein the ends on the same direction are referred to as first ends 21 and the opposite ends are referred to as second ends 22. The conveyance plates 2A, 2B are arranged, in a manner of being alternate with each other, on the conveyor chains 12 in such a way that the first ends 21 are fixed on the conveyor chains 12 and the second ends 22 are not fixed and are free ends that are movable with respect to the conveyor chains 12, wherein the second ends of the first conveyance plates 2A are respectively positioned on the first ends of the second conveyance plates 2B adjacent thereto; and the second ends of the second conveyance plates 2B are respectively positioned on the first ends of the first conveyance plates 2A adjacent thereto. As such, the outer surface of the entire loop of the conveyor chains 12 are completely mounted with and covered by the conveyance plates with the adjacent conveyance plates partly overlapping each other to eliminate any potential gap or clearance between adjacent ones of the conveyance plates so as to help prevent the fabric from being get stuck or jammed in the gap during conveyance by the conveyor.

The fabric that is conveyed by the conveyor 1 may absorb and hold a large quantity of dye liquid therein. To allow the dye liquid contained in the fabric to be smoothly discharged out of the conveyor for separation of the fabric and the liquid, the present invention is structured to include a plurality of through holes (not shown in the drawings) extending through each of the first conveyance plates 2A and the second conveyance plates 2B. As such, the dye liquid contained in the fabric may be acted upon by the gravity to fall through the through holes and return to a bottom of the interior of the machine body.

Further, since the chemical dye liquid that is used for dyeing fabric may exhibit certain property of corrosion, to extend the service life of the conveyor, the present invention is preferably made up of conveyance plates that are made of a rigid or stiff material that is resistant to corrosion or a corrosion resistant coating layer may be provided on the rigid or stiff material.

Further, to prevent the fabric positioned on the conveyance plates from being damaged due to excessive abrasion between the fabric and the conveyance plates, the present invention is preferably made up of conveyance plates having surfaces that are subjected to polishing treatment to form smooth surfaces, or a surface coating is provided to reduce frictional resistance or to enhance corrosion resistance.

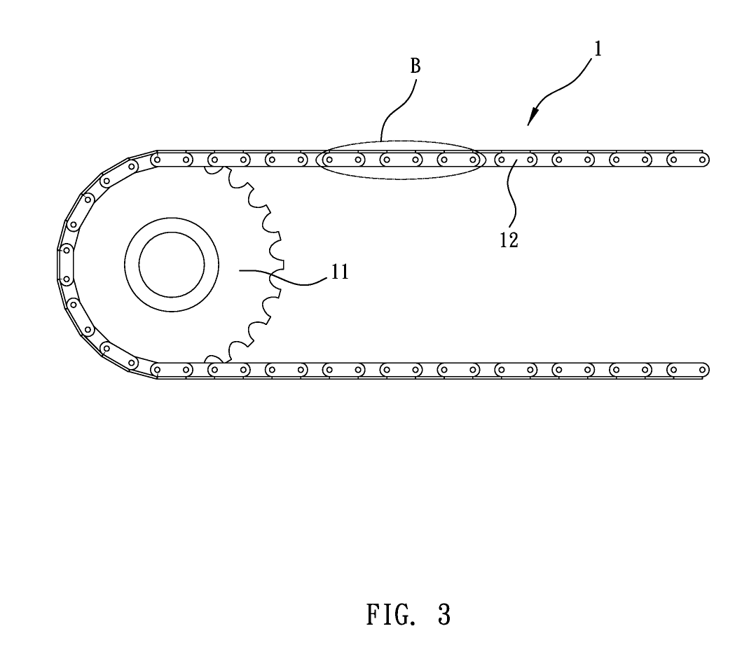

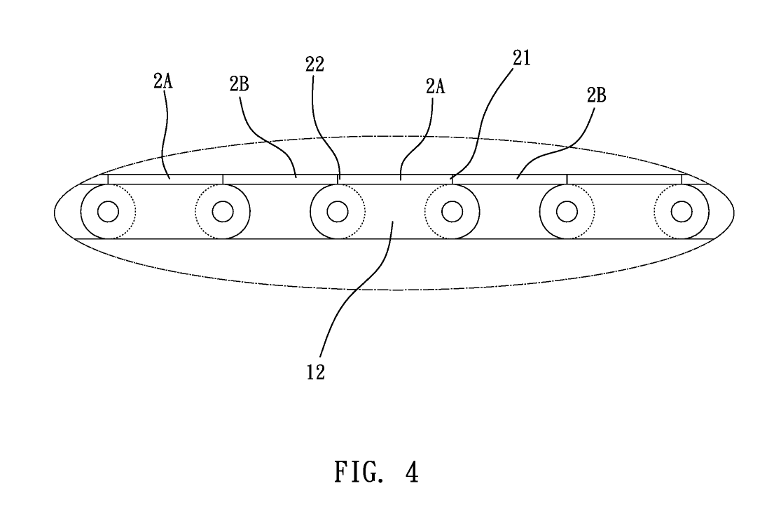

As shown in FIGS. 3 and 4, the present invention provides a structure of a conveyor 1 for use in a conveyor driven fabric dyeing machine, which as a second embodiment, comprises at least one pair of conveyor chains 12 that are arranged parallel and a driver roller 11 that guides and drives the conveyor chains 12. The conveyor 1 is arranged in an interior space of a machine body of the fabric dyeing machine to convey fabric (not shown in the drawings). In other words, the fabric is positioned on the conveyor 1 and the conveyor 1, when driven by the driver roller 11 to move, brings the fabric to move in a cyclic circulating manner.

In the conveyor, a plurality of conveyance plates are provided between and straddling the conveyor chains 12. In this specification, the conveyance plates are divided into a plurality of first conveyance plates 2A and second conveyance plates 2B that are arranged alternate with each other. The first conveyance plates 2A and the second conveyance plates 2B each have two end edges on two opposite ends thereof, wherein the ends on the same direction are referred to as first ends 21 and the opposite ends are referred to as second ends 22. The first conveyance plates 2A and the second conveyance plates 2B are arranged on the conveyor chains 12 in a manner of being alternate with each other and the first ends 21 are fixed on the conveyor chains 12 and the second end 22 are not fixed and are free ends that are straddling and supported on the conveyor chains 12, so that an outside surface of the entire loop of the conveyor chains 12 are completely mounted with and covered by the conveyance plates.

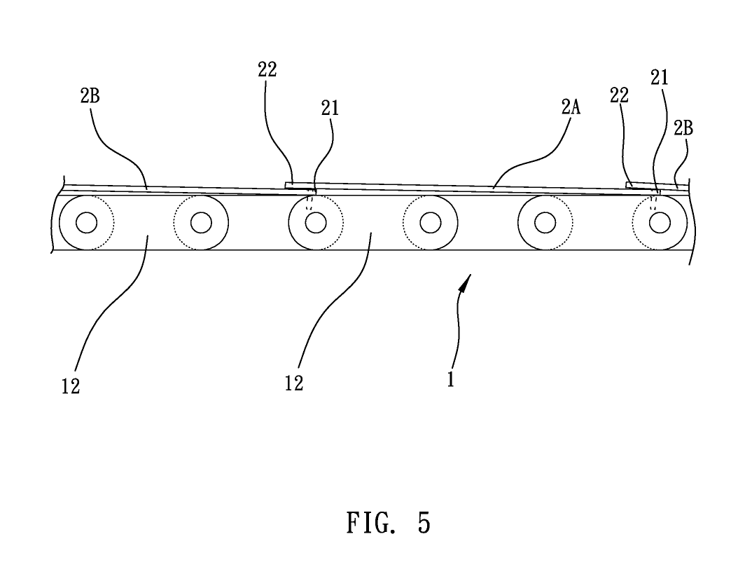

As shown in FIG. 5, the present invention provides a structure of a conveyor 1 for use in a conveyor driven fabric dyeing machine, which, as a third embodiment, comprises conveyance plates 2A that are extended to cover multiple sections of the conveyor chains 12. In other words, the multiple sections of the conveyor chains 12 share one common first conveyance plate 2A or one common second conveyance plate 2B, so that the numbers of the first conveyance plates 2A and the second conveyance plates 2B used can be reduced.

The fabric that is conveyed by the conveyor 1 may absorb and hold a large quantity of dye liquid therein. To allow the dye liquid contained in the fabric to be smoothly discharged out of the conveyor for separation of the fabric and the liquid, the second embodiment of the present invention may be structured such to include a plurality of through holes (not shown in the drawings) extending through each of the first conveyance plates 2A and the second conveyance plates 2B. As such, the dye liquid contained in the fabric may be acted upon by the gravity to fall through the through holes and return to a bottom of the interior of the machine body.

Similarly, the present invention is preferably made up of conveyance plates that are made of a rigid or stiff material that is resistant to corrosion and surfaces of the conveyance plates are subjected to polishing treatment to form smooth surfaces.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An improved conveyor structure for use with a conveyor driven fabric dyeing machine, the conveyor comprising at least one pair of convey chains that are arranged parallel to each other and a driver roller to guide and drive the conveyor chains;
wherein a plurality of the conveyance plates are arranged between and straddle between the conveyor chains.

2. The improved conveyor structure for use with a conveyor driven fabric dyeing machine according to claim 1, wherein the conveyance plates have an extended length to cover multiple sections of the conveyor chains.
